(19) United States
(12) Patent Application Publication
(10) Pub. No.: US 2002/0005956 A1
(43) Pub. Date: Jan. 17, 2002

(54) Method and device for measuring three-dimensional position

(76) Inventor: Kazuya Kiyoi, Osaka (JP)

Correspondence Address: Barry E. Bretschneider, Morrison & Foerster LLP, 2000 Pennsylvania Avenue, N.W., Washington, DC, 20006-1888, US

(21) Appl. No.: 09/900,190

(22) Filed: Jul. 9, 2001

(30) Foreign Application Priority Data
Jul. 12, 2000 (JP) 2000-210921

(51) Int. Cl. G01B 11/24

(52) U.S. Cl. 356/601

(57) ABSTRACT

Object of the present invention is to generate highly reliable three-dimensional data. The invention provides a method and an apparatus for measuring a three dimensional position of a point on an object by calculating a centroid of a temporal distribution or a spatial distribution of a light reception amount based on a set of light reception data indicating light reception intensity of a light reflected at the object. The three-dimensional measurement apparatus comprises a calculator for calculating a centroid based on the light reception data exceeding a threshold value, a setting section capable of varying the threshold value and a judgment section for determining a difference between a centroid based on the light reception data exceeding a threshold value and a centroid based on the light reception data exceeding another threshold value and judging if the centroids are correct or not based on the difference.

### BACKGROUND OF THE INVENTION

This application is based on Japanese Patent Application No. 2000-210921 filed in Japan on Jul. 12, 2000, the contents of which are hereby incorporated by reference.

1. Field of the Invention

The present invention relates to a method and an apparatus for measuring a three-dimensional position of a point on an object.

2. Description of the Prior Art

A non-contact type three-dimensional measurement system for obtaining shape information by optically scanning an object is used for inputting data into a CG system or a CAD system, physical inspection and so on.

During scanning by projecting a slit light or a spotlight, part of an object is irradiated at a certain time point. At such time point, in the case of the slit light projection method (so-called the light-section method), for example, a bright line which curves in accordance with a relief of the irradiated part of the object appears on an imaging surface. Position of the bright line on the imaging surface specifies an incident angle of the slit light at which the slit light is made incident to the imaging surface after being reflected at the object. By employing the triangulation method, distances from reference points of light projection and light reception to the object are determined from the incident angle, a projection angle and length of baseline (distance between a starting point of the projection and the light-reception reference point) of the slit light. It is possible to obtain a set of data (three-dimensional data) for specifying a shape of the object by periodically sampling the brightness of each of pixels on the imaging surface during the scanning.

In the above measurement, a centroid operation is useful for improving resolution. More specifically, a maximum intensity position I when a light is projected at a certain angle is determined by the following expression based on a light reception intensity x and a position m of each of some pixels instead of simply detecting the brightest pixel.

I=Σm·xₘ/Σxₘ

The maximum intensity position I is called “spatial centroid” since it is a centroid of spatial distribution of light reception intensities on a light reception surface (imaging surface). Calculation of the spatial centroid contributes to improvement of the resolution when compared with the use of a value determined depending on pixel pitch.

Further, Japanese Patent Unexamined Publication No. 10-206132 (U.S. Pat. No. 6,151,118) discloses a method for determining a time point of maximum intensity J by the following expression based on a light reception intensity x and sampling time i of a noted pixel.

J=ΣI·xᵢ/Σxᵢ

The time point of maximum intensity J is called “temporal centroid” since it is a centroid of a temporal distribution of light reception intensities on a light reception surface. The temporal centroid represents a time elapsed from a start of scanning and thus specifies a projection angle (time and angle are proportional to each other in isometric speed scanning). Incident angle of each of the pixels is determined with relation to a lens and, therefore, the triangulation can be performed for each of the pixels. Calculation of the temporal centroid contributes to improvement of the resolution compared with the use of a value determined depending on sampling period.

In both the cases of the spatial centroid and the temporal centroid, precision of operation result is improved as quantity of sampling data increases. However, operation error is typically caused by environmental noise superimposing photoelectric conversion signals. Therefore, calculation of centroid is usually performed based on light reception data exceeding a threshold value as disclosed in Japanese Examined Patent Publication No. 8-10310.

One of the problems detected with the conventional methods is that noise data are undesirably included in three-dimensional data when a so-called multiple reflection occurs, i.e., when a light reflected at a first position and a second position of an object is made incident to a light reception surface along with a light reflected at the first position of the object, since a centroid operation is carried out based on erroneous information in the case of multiple reflection. In utilizing three-dimensional data, it is often difficult to judge whether a set of data of each measurement point is normal data or noise data. Further, when there is a possibility of noise data, a considerable labor is involved such as judging whether or not the data are noise data by referring to a two-dimensional image of the object complementarily pictured in measurement and removing the noise data thus detected.

### SUMMARY OF THE INVENTION

An object of the present invention is to generate three-dimensional data of high reliability.

According to an embodiment of the present invention, a three-dimensional position of a point of an object is calculated based on a correct centroid which is obtainable by: scanning the object by projecting thereto a reference light; receiving a light reflected at the object to obtain light reception data indicating a light reception intensity of the reflected light; calculating a first centroid of a temporal distribution or a spatial distribution of a light reception amount based on part of the light reception data that exceeds a first threshold value; calculating a second centroid of a temporal distribution or a spatial distribution of a light reception amount based on part of the light reception data that exceeds a second threshold value; determining a correct centroid by comparing the first centroid with the second centroid. Thus, it is possible to eliminate erroneous data and to substantially minimize reduction of measurement points otherwise caused by invalidating part of measurement result.

According to another embodiment of the present invention, a three-dimensional position of a point of an object is calculated based on a correct centroid which is obtainable by: scanning the object by projecting thereto a reference light; receiving a light reflected at the object to obtain light reception data indicating a light reception intensity of the received light; calculating a centroid of a light reception amount based on part of the light reception data that exceeds a threshold value; judging if the centroid is correct or not based on a temporal range or a spatial range wherein light reception data exceed the threshold value.

These and other objects and constituents of the present invention will become more apparent by the following descriptions of the preferred embodiments with reference to drawings.

### BRIEF DESCRIPTION OF THE DRAWINGS

FIG. 1 is a block diagram showing a three-dimensional measurement apparatus according to an embodiment of the present invention.

FIG. 2 is a block diagram showing an electric circuit of a three-dimensional camera.

FIG. 3 is a block diagram showing a centroid operation circuit.

FIGS. 4A and 4B each illustrates a centroid checkout according to a first embodiment of the present invention.

FIG. 5 is a flowchart showing an operation of the three-dimensional camera according to the first embodiment.

FIG. 6 is a flowchart showing a first example of a host operation according to the first embodiment.

FIG. 7 is a flowchart showing a second example of the host operation according to the first embodiment.

FIGS. 8A and 8B each illustrates a centroid checkout according to a second embodiment.

FIG. 9 is a flowchart showing an operation of a three-dimensional camera according to the second embodiment.

FIG. 10 is a flowchart showing a host operation according to the second embodiment.

### DESCRIPTION OF THE PREFERRED EMBODIMENTS

(First Embodiment)

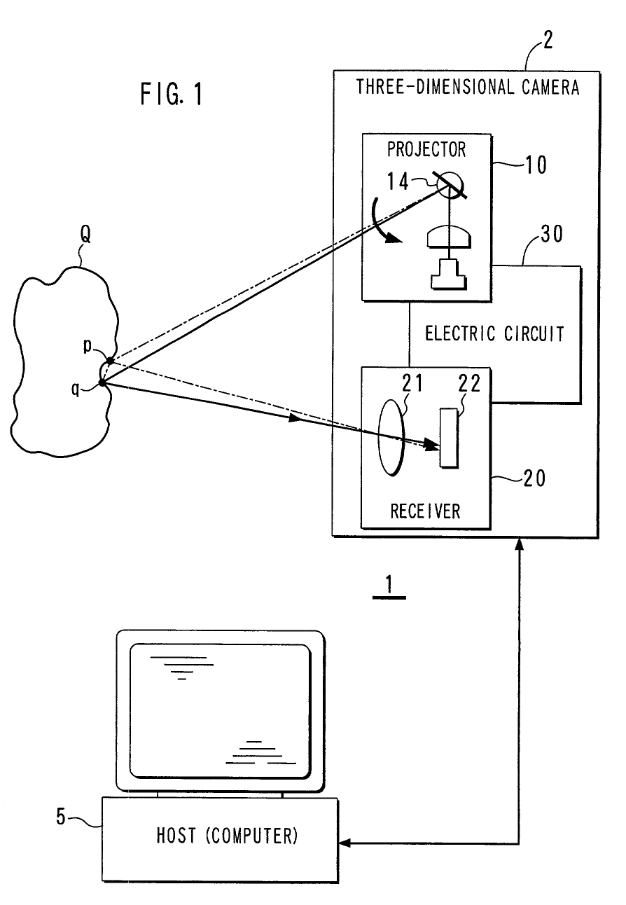

FIG. 1 is a block diagram showing a three-dimensional measurement apparatus according to the present invention.

The three-dimensional input system 1 comprises a three-dimensional camera 2 which is a light projection/reception portion used for measurement by the slit light projection method and a host 5 for processing output data of the three-dimensional camera 2.

In a light projection portion (projector) 10 of the three-dimensional camera 2, laser beam projected from a light source is formed into a slit light by means of a unit of lenses. The slit light is so deflected by a scanner 14 as to irradiate a position q on an object Q that is an object for measurement. Part of the slit light being reflected and diffused at the position q returns to a light reception portion (receiver) 20 and then enters an area sensor 22 (two-dimensional imaging device) through a unit of lenses 21. In the case where a light reflected at a position p, which is different from the position q, is relatively high in intensity, the light reflected at the position p enters the area sensor 22 through the light path leading from the position q, thereby causing multiple reflection. Incidence position of the light that returns directly from the position p to the light reception portion 20 is different from an incidence position of the light returning from the position q. In the case of determining a temporal centroid, a correct temporal centroid can be obtained with respect to the position p, but not with respect to the position q. On the other hand, in the case of determining a spatial centroid, a correct spatial centroid can be obtained with respect to the position q, but not with respect to the position p. An electric circuit 30 provided in the three-dimensional camera 2 has an operation function for calculating a centroid.

The host 5 is a computer system comprising a display, a keyboard and a pointing device and is connected with the three-dimensional camera 2 by, for example, a USB cable. The host 5 serves to judge whether or not the centroid calculated by the three-dimensional camera 2 is correct.

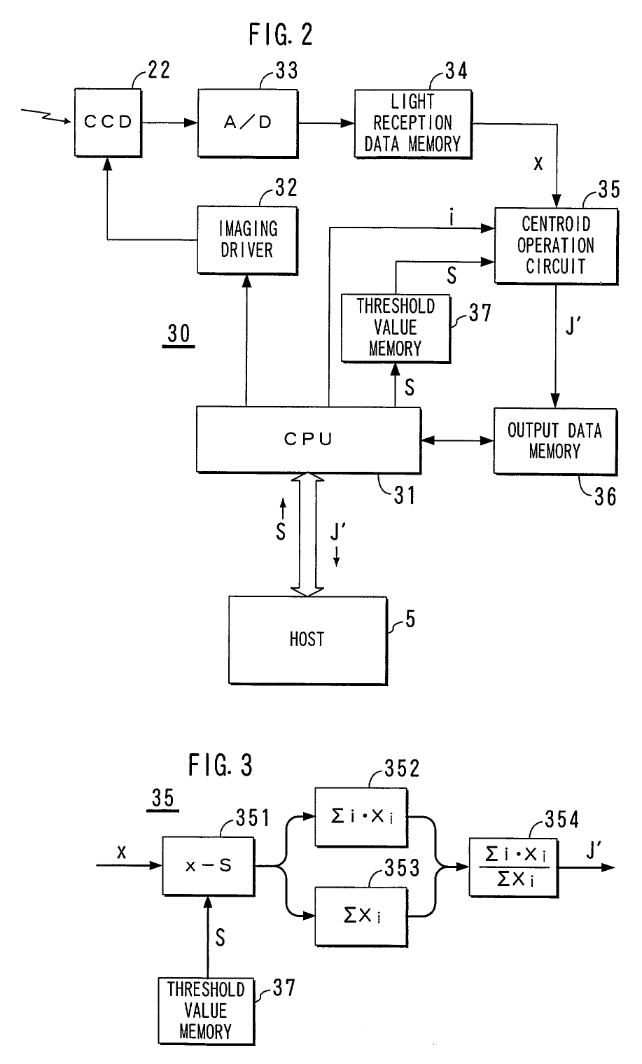

FIG. 2 is a block diagram showing the electric circuit of -the three-dimensional camera.

The area sensor 22 may be either a CCD type or a MOS type. The area sensor 22 outputs photoelectric conversion signals indicating a light reception amount of each of a predetermined number of pixels in synchronization with a clock from an imaging driver 32. The photoelectric signals are subjected to sample and hold processing at an A/D converter 33 to be converted into digital light reception data. The light reception data are stored once in a light reception data memory 34 that serves as a buffer and then sent to a centroid operation circuit 35 sequentially by a set of the light reception data for one pixel.

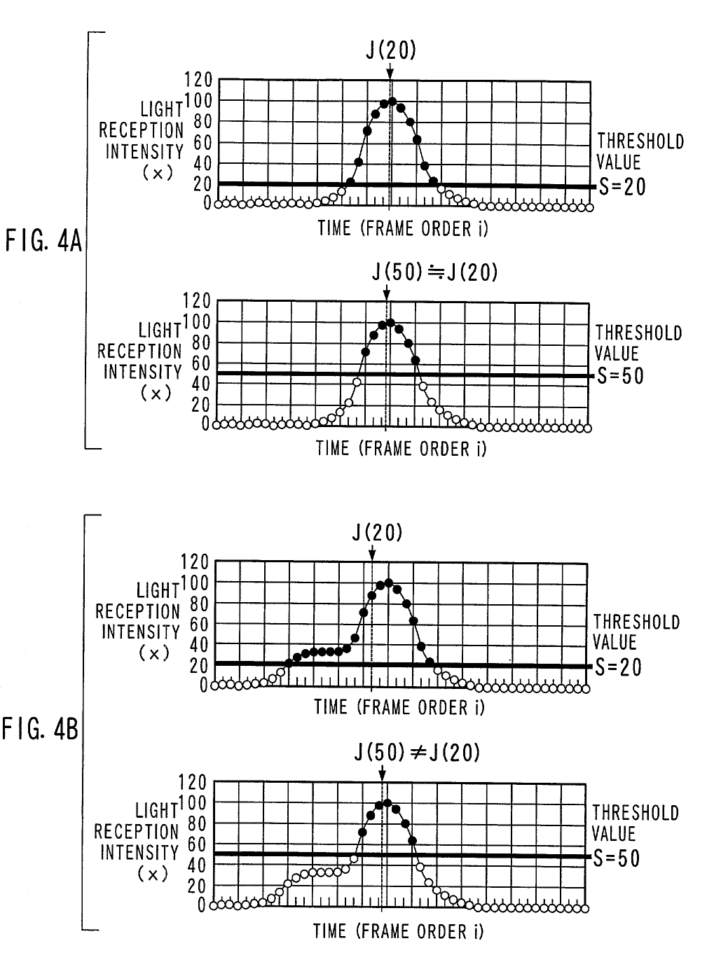

In each of the graphs shown in FIGS. 4A and 4B, a set of light reception data for one pixel are plotted by dots and circles. In one centroid operation, the set of the light reception data for one pixel is an object for processing. In the present specification and claims, the set of the light reception data is sometimes referred to simply as “light reception data”.

Among the light reception data sequentially sent to the centroid operation circuit 35 by one set for one pixel in parallel with scanning, light reception data whose data value x is higher than a threshold value S are used for calculation of a temporal centroid in the centroid operation circuit 35. The calculated temporal centroid is accumulated in an output data memory 36 as a virtual centroid J′ and then transmitted to the host 5 via a CPU 31. The CPU 31 serves to set the threshold value S sent from the host 5 in a threshold value memory 37.

FIG. 3 is a block diagram showing the centroid operation circuit.

The centroid operation circuit 35 comprises a subtraction unit 351, a first addition unit 352, a second addition unit 353 and a division unit 354 and performs an operation for each of pixels in the area sensor 22 with respect to a set of the light reception data for a number of frames (a number of samplings).

The subtraction unit 351 serves to subtract the threshold value S from the light reception data value x to obtain a subtraction data value X and sends only positive subtraction data value to the first addition unit 352 and the second addition unit 353. Thus, part of the light reception data that exceeds the threshold value is extracted. Subtraction data value of a noted pixel in ith frame is represented by Xᵢ (“i” represents a discrete value indicating a time elapsed from a start of scanning). The first addition unit 352 multiplies the subtraction data value Xᵢ by time i and cumulates the obtained products. The second addition unit 353 cumulates the subtraction data value Xᵢ. A cumulative value of the first addition unit 352 after finishing the cumulation of the last frame is divided by a cumulative value of the second addition unit 353 after finishing the cumulation of the last frame, and a temporal centroid thus obtained is output as a virtual centroid J′ to the host 5. The host 5 judges whether or not the virtual centroid J′ is correct.

FIGS. 4A and 4B each illustrates a centroid checkout according to the first embodiment. In FIGS. 4A and 4B, a dot indicates that a light reception intensity at that point is higher than the threshold value, and a circle indicates that a light reception intensity is lower than the threshold value.

Temporal distribution of the light reception intensity of the noted pixel is usually in the form of a symmetrical single peak type as shown in FIG. 4A. Accordingly, the centroid J(20) when the threshold value is low (S=20) and the centroid J(50) when the threshold value S is high (S=50) are almost the same. On the other hand, in the case of the multiple reflection, the distribution line forms a curve which lacks in symmetry as shown in FIG. 4B. Accordingly, the centroids differ much to each other depending on the threshold values in the case of multiple reflection. Therefore, if centroids obtained in the case of increasing the threshold value stepwise are almost the same, it is assumed that the centroids are free from the multiple reflection and thus are correct. Error is reduced as a number of data is increased and, therefore, it is preferable to select, as a measurement result, a centroid obtained based on the minimum threshold value from the correct centroids.

The judgment method described above is applicable to a circuit for calculating a spatial centroid. In the case of calculating the spatial centroid, the time i (abscissa) in FIGS. 4A and 4B should be replaced by the pixel position m.

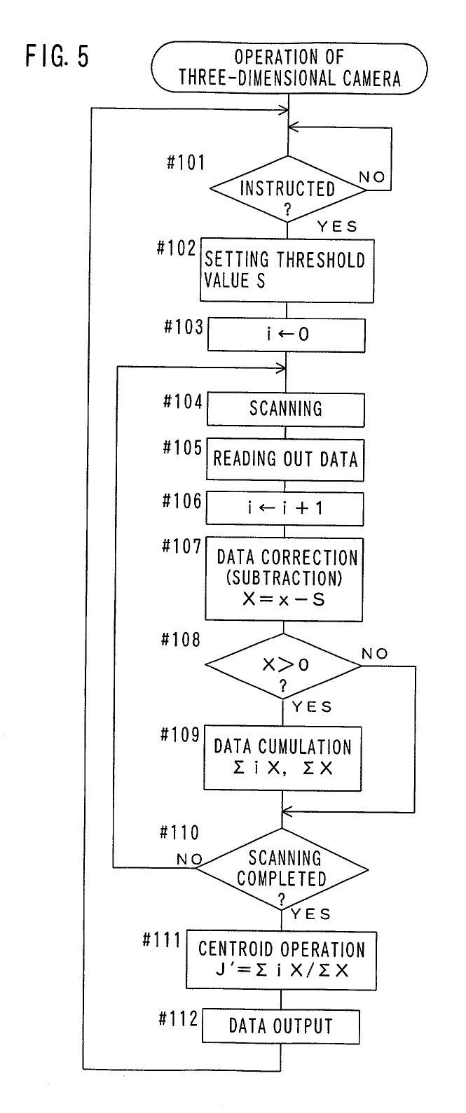

FIG. 5 is a flowchart showing an operation of the three-dimensional camera of the first embodiment.

The threshold value S is set in the threshold value memory 37 of the three-dimensional camera upon receiving instructions from the host 5 (#101 and #102). The time i is initialized to start scanning, and light reception data for one frame are transmitted from the light reception data memory 34 to the centroid operation circuit 35 so as to increment the time i (#103 to #106). Part of the light reception data that exceeds the threshold value is extracted, and the cumulation described above is performed for the centroid operation (#107 to #109). The steps #104 to #109 are repeated until the scanning of a predetermined angular area completes. After completing the scanning, a temporal centroid is calculated by division based on the cumulative value, and the calculated temporal centroid is sent to the host 5 as a virtual centroid J′ (#110 to #112).

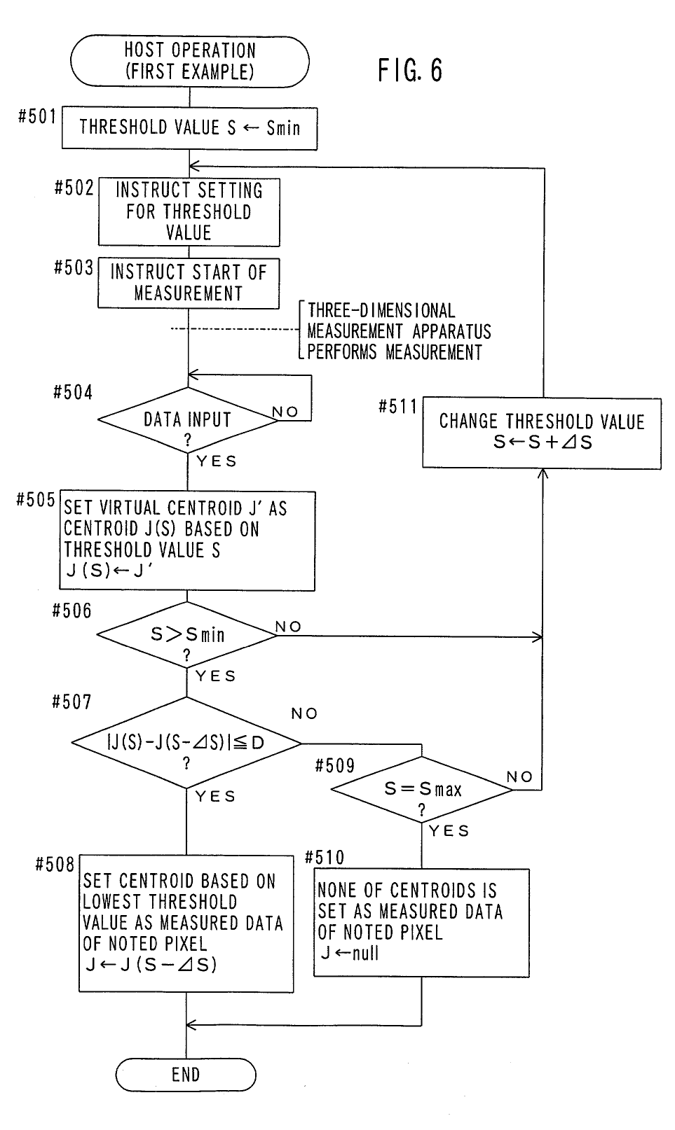

FIG. 6 is a flowchart showing a first example of a host operation according to the first embodiment.

The threshold value is set to the minimum value (lower limit) Smin, and setting of the threshold value and start of measurement are instructed to the three-dimensional camera (#501 to #503). The host 5 stores the virtual centroid J′ as a centroid J(S) based on the current threshold value upon input of the data sent from the three-dimensional camera (#504 and #505). Then, the threshold value is increased by a variation range AS when the threshold value is the minimum value Smin, and the operation returns to the step #502 whereby the three-dimensional camera 2 is instructed of setting of a new threshold value and start of re-measurement (#506 and #511).

If the threshold value is not the minimum value Smin in the step #506, it means that the scanning have been performed twice or more. In this case, a difference between the centroid J(S) at a current threshold value and a centroid J(S−ΔS) at a threshold value lower than the current threshold value by one step is detected (#507) with respect to each pixels. If the difference between the centroids is lower than an allowable reference value D, the centroid j(S−ΔS) based on the threshold value S-AS is employed as measured data (centroid J) (#508). In the case where there is a pixel having the difference between the centroids higher than the allowable reference value D, the threshold value S is further increased by the variation range ΔS (#511) after confirming that the threshold value S does not reach the maximum value (upper limit) Smax (#509). In the case where the threshold value has reached the maximum value Smax, none of the centroids is employed as the measured data with respect to pixels having the difference between the centroids higher than the allowable reference value D, i.e., such centroids are substantially invalidated as the measured data (#510).

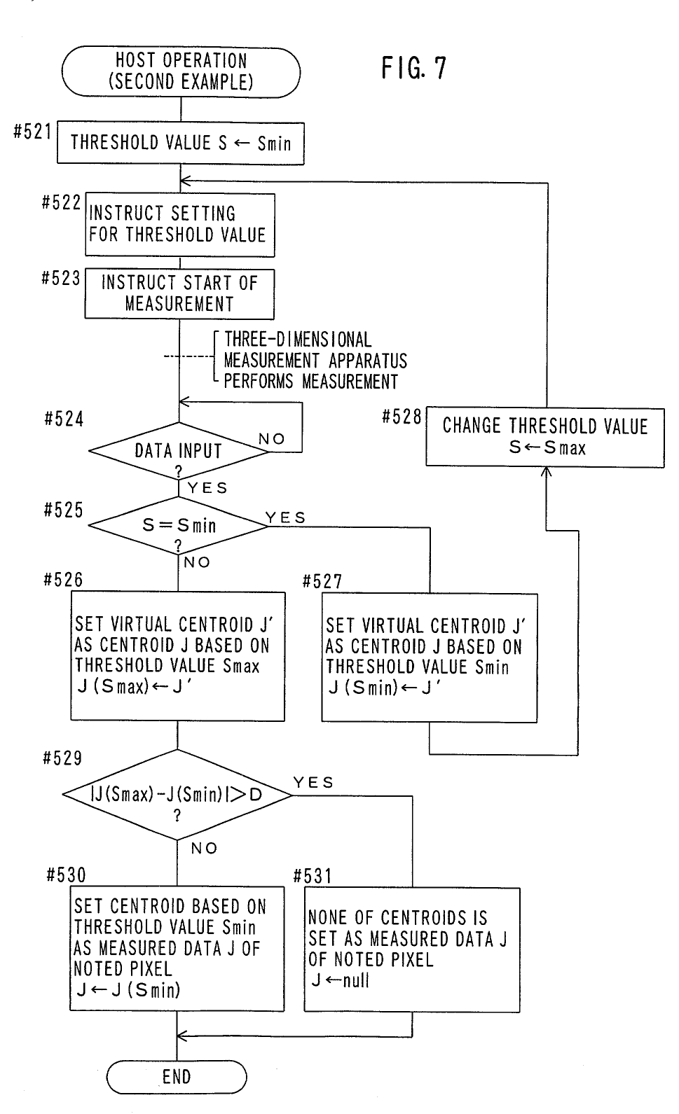

FIG. 7 is a flowchart showing a second example of the host operation according to the first embodiment.

The second example (#521 to #531) is an example of an operation for switching the threshold value S between the minimum value Smin and the maximum value Smax. The processing performed in the second example is basically the same as that of the first example.

The threshold value is set to the minimum value Smin, and setting of the threshold value and start of measurement are instructed to the three-dimensional camera 2 (#521 to #523). Upon receiving the data input from the three-dimensional camera, the host 5 checks a current threshold value S (#524 and #525). If the threshold value S is the minimum value Smin, a virtual centroid J′ is stored in the host 5 as a centroid J(Smin) based on the threshold value Smin (#527). Then, the threshold value is switched to the maximum value Smax (#528), and operation returns to the step #522 to instruct setting of a new threshold value and start of re-measurement to the three-dimensional camera 2.

If the threshold value S is not the minimum value Smin in the step #525, it means that the scanning have been performed twice or more. In this case, the virtual centroid J′ is stored in the host 5 as a centroid J(Smax) based on the threshold vale Smax (#526). Then, a difference between the centroid J(Smax) based on the current threshold value Smax and the centroid J(Smin) based on the minimum threshold value Smin is detected for each pixels. With respect to a pixel having the difference between the centroids lower than the allowable reference value D, the centroid J(Smin) based on the threshold value Smin is employed as measured data (centroid J) (#503). With respect to a pixel having the difference between the centroids higher than the allowable reference value D, none of centroids is employed as the measured data, i.e., such centroids are substantially invalidated as the measured data (#531).

(Second Embodiment)

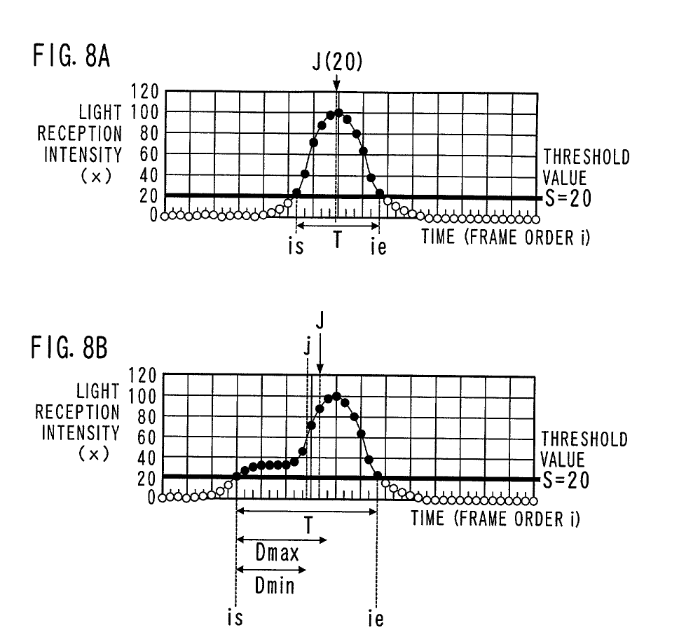

FIG. 8 illustrates a centroid checkout according to the second embodiment.

Temporal distribution of a light reception intensity of a noted pixel is usually in the form of a symmetrical single peak type as shown in FIG. 8A. Accordingly, temporal range T wherein a light reception intensity x exceeds a threshold value S is relatively short even when the threshold value S is relatively low (S=20). On the other hand, in the case of multiple reflection, the distribution line forms a curve which lacks in symmetry as shown in FIG. 8B, and the temporal range T wherein the light reception intensity x exceeds the threshold value S is relatively long when the threshold value S is relatively low. Further, a centroid J obtained by a centroid operation based on data of the temporal range T is often notably different from a median value j of the temporal range T.

Therefore, it is possible to check out the centroid J by comparing the temporal range T with limit values Dmax and Dmin in a predetermined allowable range. Above centroid checkout will be more reliable if a checkout of the difference between the centroid J and the median value j is performed in addition to the centroid checkout. The centroid checkout can also be applied to the calculation for a spatial centroid.

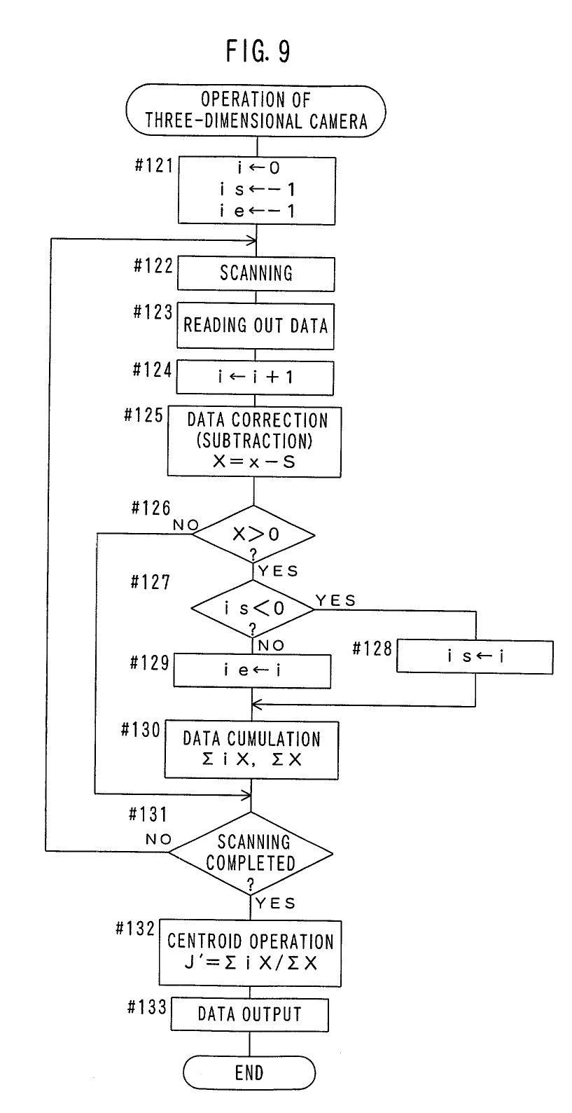

FIG. 9 is a flowchart showing an operation of the three-dimensional camera according to the second embodiment.

Scanning starts after setting time i which is a parameter representing a time for the centroid operation (time elapsed from the start of the scanning) to 0 and setting a front end time point is and a rear end time point ie of the temporal range T to −1 (#121 and #122). Then, a set of light reception data for one frame is transmitted from the data memory 34 to the centroid operation circuit 35, and the time i is incremented (#123 and #124). After that, the light reception data higher than the threshold value are extracted, and the temporal range is counted (is and ie are updated) to proceed with cumulation for the centroid operation (#125 to #130). The steps #122 to #130 are repeated until the scanning of a predetermined angle area completes (#131). After the completion of the scanning, a temporal centroid is calculated by division based on the cumulative value, and the calculated temporal centroid is sent to the host 5 as a virtual centroid J′ (#131 to #133).

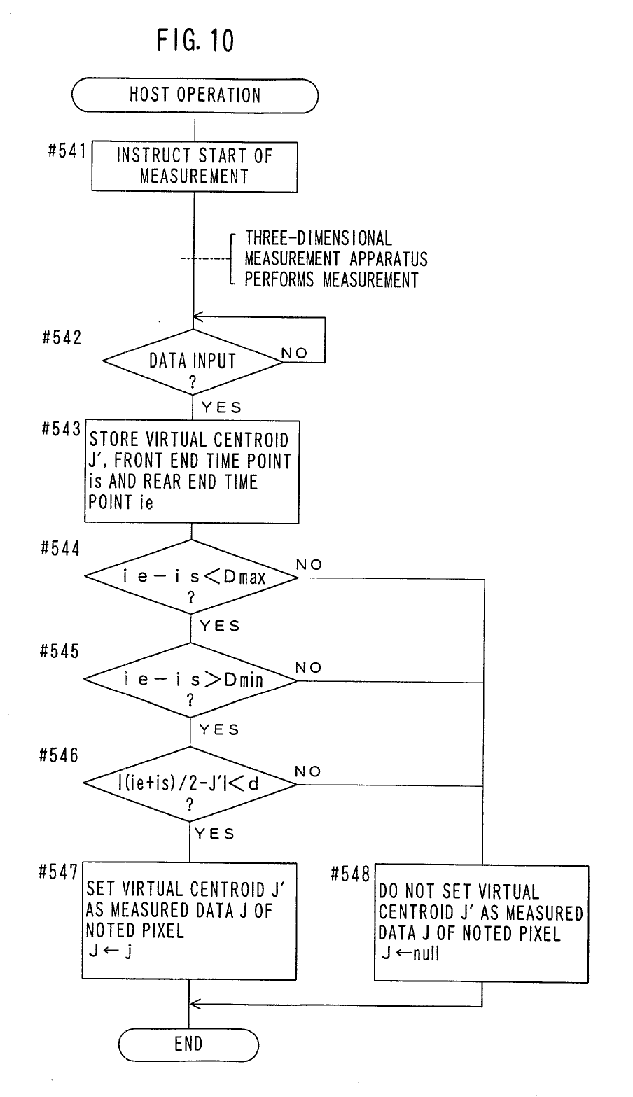

FIG. 10 is a flowchart showing an operation of a host according to the second embodiment.

Setting of a threshold value and start of measurement are instructed to the three-dimensional camera 2 (#541). The host 5 stores a virtual centroid J′, a front end time point is and a rear end time point ie upon reception of the data input from the three-dimensional camera 2 (#542 and #543).

With respect to a pixel having a difference between the rear end time point ie and the front end time point (which represents length of the temporal range T) in an allowable range and a difference between the virtual centroid j′ and a median value j [=(ie+is)/2] of the temporal range T lower than a reference value d, the virtual centroid J′ is used as measured data (centroid J) (#544 to #547). With respect to a pixel which do not satisfies above conditions, the virtual centroid J′ is not used as the measured data, i.e. such virtual centroid is substantially invalidated as the measured data (#544 to #546 and #548).

In the above-described embodiments, the three-dimensional camera 2 and the host 5 are separated bodies; however, it is possible to apply the present invention to an equipment component wherein functions of the three-dimensional camera and the host are integrally contained in a housing. The reference light is not limited to the slit light, and a spotlight may be used instead of the slit light.

While the present invention has been described with respect to a limited number of embodiments, those skilled in the art will appreciate numerous modifications and variations therefrom. It is intended that the appended claims cover all such modifications and variations as fall within the spirit and scope of the present invention.

What is claimed is:

1. A method for measuring a three-dimensional position of a point on an object, comprising the steps of:
scanning the object by projecting thereto a reference light;
receiving a light reflected at the object to obtain a set of light reception data indicating a light reception intensity of the received light;
calculating a first centroid of a temporal distribution or a spatial distribution of a light reception amount based on the light reception data exceeding a first threshold value;
calculating a second centroid of a temporal distribution or a spatial distribution of a light reception amount based on the light reception data exceeding a second threshold value;
detecting a correct centroid by determining a difference between the first centroid and the second centroid; and
calculating the three-dimensional position of the point based on the correct centroid.

2. A method for measuring a three-dimensional position of a point on an object, comprising the steps of:
scanning the object by projecting thereto a reference light;
receiving a light reflected at the object to obtain a set of light reception data indicating a light reception intensity of the received light;
calculating a centroid of a light reception amount based on the light reception data exceeding a threshold value;
judging if the centroid is correct or not based on a temporal range or a spatial range wherein the light reception data exceed the threshold value; and
calculating the three-dimensional position of the point based on the correct centroid.

3. An apparatus for measuring a three-dimensional position of a point on an object, comprising:
a projector for scanning the object by projecting a reference light;
a receiver for receiving a light reflected at the object and outputting a set of light reception data indicating a light reception intensity of the received light:
a calculator for calculating a centroid of a light reception amount based on the light reception data exceeding a threshold value;
a setting section for setting the threshold value; and
a judgment section for determining a difference between a centroid based on the light reception data exceeding a threshold value and a centroid based on the light reception data exceeding another threshold value and judging if the centroids are correct or not based on the difference.

4. The apparatus according to claim 3, wherein
the judgment section comprises
performing a centroid checkout by calculating a centroid for each of threshold values until a correct centroid is found or all the centroids are checked; and
validating measurement with respect to a point with which a correct centroid is found.

5. The apparatus according to claim 3, wherein
the setting section switches the threshold value between two threshold values.

6. An apparatus for measuring a three-dimensional position of a point on an object, comprising:
a projector for scanning the object by projecting a reference light;
a receiver for receiving a light reflected at the object and outputting a set of light reception data indicating a light reception intensity of the received light;
a calculator for calculating a centroid of a light reception amount based on the light reception data exceeding a threshold value; and
a judgment section for judging if the centroid is correct or not based on a temporal range or a spatial range wherein the light reception data exceed the threshold value.

7. The apparatus according to claim 6, wherein
the judgment section judges if a centroid of a noted pixel on a light reception surface is correct or not by comparing a temporal range of the noted pixel with a temporal range of another pixel.

8. The apparatus according to claim 6, wherein
the judgment section judges if a centroid of a noted pixel on a light reception surface is correct or not by comparing a temporal range of the noted pixel with a predetermined reference range.
